(19) United States
(12) Patent Application Publication
(10) Pub. No.: US 2007/0180673 A1
(43) Pub. Date: Aug. 9, 2007

(54) Method of assembling a carriage assembly

(75) Inventors: Hiroshi Kobayashi, Kawasaki (JP); Hidehiko Kira, Kawasaki (JP); Naoki Ishikawa, Kawasaki (JP); Takayoshi Matsumura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/444,292

(22) Filed: May 31, 2006

(30) Foreign Application Priority Data
Feb. 7, 2006 (JP) 2006-29773

(51) Int. Cl. B23P 11/00; B21D 39/00

(52) U.S. Cl. 29/407.01; 29/407.05; 29/407.07; 29/505

(57) ABSTRACT

There is provided a method of assembling a carriage assembly that can crimp suspensions to carriage arms by applying ultrasonic vibration to a crimping tool without causing deformation of the suspensions and the like. The method of assembling a carriage assembly aligns attachment holes provided in front ends of carriage arms and crimping portions provided on suspensions to set the suspensions on the carriage arms and then presses a metal ball through crimping holes provided in the crimping portions while applying ultrasonic vibration to a crimping tool to crimp the suspensions to the carriage arms. The suspensions are crimped to the carriage arms by detecting stress that acts on the crimping tool when the metal ball is pressed in by the crimping tool and controlling the amplitude of the ultrasonic vibration applied to the crimping tool so as to increase and decrease in accordance with the magnitude of the stress.

### BACKGROUND OF THE INVENTION

1. Field of the Invention

The present invention relates to a method of assembling a carriage assembly for use in a magnetic disk apparatus, and in more detail to a method of assembling a carriage assembly assembled by crimping together carriage arms and suspensions.

2. Related Art

FIG. 6 schematically shows the overall construction of a carriage assembly used in a magnetic disk apparatus. The carriage assembly is formed by attaching suspensions 12 to the front ends of carriage arms 10, a plurality of which are disposed in parallel in accordance with the intervals at which magnetic media are disposed. A slider 14 equipped with a magnetic head used to record and reproduce information is mounted on the front end of each suspension 12. A flexible circuit board 16 is attached to side surfaces of the carriage arms 10, and the magnetic heads formed on the sliders 14 and a control unit 18 are electrically connected via the flexible circuit board 16.

FIG. 7 shows a conventional method of fixing (attaching) the suspensions 12 to the carriage arms 10. After the suspensions 12 have been set on the carriage arms 10 by aligning crimping portions 12a formed at base portions of the suspensions 12 with attachment holes 10a formed in the front ends of the carriage arms 10, a metal ball 20 formed with a slightly larger diameter than an inner diameter of crimping holes 12b provided in the crimping portions 12a is pressed into the crimping holes 12b and is passed through the crimping holes 12b to fix the suspensions 12 to the carriage arms 10. Since the pressure/heat applying head 20 is formed with a slightly larger diameter than the crimping holes 12b, when the metal ball 20 passes through the crimping holes 12b, the crimping portions 12a are pressed open to fix the suspensions 12 to the carriage arms 10 by crimping.

The metal ball 20 is pressed into the crimping holes 12b using a crimping tool 22 formed in a rod-like shape. As shown in FIG. 6, since the carriage assembly is equipped with a plurality of carriage arms 10 disposed in parallel, during an actual crimping operation, a single metal ball 20 moves downward from the uppermost carriage arm 10 and is successively passed through the crimping holes 12b to crimp the suspensions 12 to the carriage arms 10. Note that instead of using a metal ball 20 and applying ultrasonic vibration to the crimping tool 22 when passing the metal ball 20 through the crimping holes 12b, a crimping method has also been proposed where an operation portion formed in a ball-like shape is integrally provided at the front end of the crimping tool 22 (see Patent Document 1).

Patent Document 1

Japanese Laid-Open Patent Publication No. 2004-127491

Ultrasonic vibration is applied to the crimping tool 22 when crimping the suspensions 12 to the carriage arms 10 as described above since when the metal ball 20 is simply pressed into the crimping holes 12b, a large crimping force acts upon the crimped parts, which can cause deformation in the suspensions 12 and/or deformation in the carriage arms 10. If ultrasonic vibration is applied to the crimping tool 22, the metal ball 20 will pass through the crimping holes 12b while vibrating, and therefore deformation of the crimped parts can be suppressed.

It is understood that when ultrasonic vibration acts on the crimping tool 22, deformation of the crimping portions is suppressed when the amplitude of the ultrasonic vibration is quite large. Conventionally, when ultrasound is applied to the crimping tool 22, ultrasonic vibration of a predetermined amplitude is applied. When doing so, if the amplitude of the ultrasonic vibration is simply increased, the metal ball 20 will become violent during crimping, preventing reliable crimping from being carried out. Also, even if the suspensions 12 are crimped to the carriage arms 10 by applying ultrasonic vibration to the crimping tool 22, when the suspensions 12 are made smaller and the thickness of the suspensions 12 is made thinner, if the crimping force is only slightly uneven, the suspensions 12 and the carriage arms 10 will become susceptible to deformation and therefore it becomes difficult to reliably attach the suspensions 12 to the carriage arms 10.

### SUMMARY OF THE INVENTION

It is an object of the present invention to provide a method of assembling a carriage assembly that can reliably crimp suspensions to carriage arms without causing deformation of the suspensions and the like when the suspensions are crimped to the carriage arms by applying ultrasonic vibration to a crimping tool.

To achieve the stated object, a method of assembling a carriage assembly according to the present invention aligns attachment holes provided in front ends of carriage arms and crimping portions provided on suspensions to set the suspensions on the carriage arms and then presses a metal ball through crimping holes provided in the crimping portions while applying ultrasonic vibration to a crimping tool to crimp the suspensions to the carriage arms, wherein the suspensions are crimped to the carriage arms by detecting stress that acts on the crimping tool when the metal ball is pressed in by the crimping tool and controlling an amplitude of the ultrasonic vibration applied to the crimping tool so as to increase and decrease in accordance with the magnitude of the stress.

Another method of assembling a carriage assembly according to the present invention aligns attachment holes provided in front ends of carriage arms and crimping portions provided on suspensions to set the suspensions on the carriage arms that are disposed on a plurality of levels and then presses a metal ball successively through crimping holes provided in the crimping portions while applying ultrasonic vibration to a crimping tool to crimp the suspensions to the carriage arms, wherein the suspensions are crimped to the carriage arms by carrying out control to not apply ultrasonic vibration to the crimping tool when the metal ball has come out of a crimping hole on an upper level and is at an intermediate position for insertion into a crimping hole on a next level.

Yet another method of assembling a carriage assembly according to the present invention aligns attachment holes provided in front ends of carriage arms and crimping portions provided on suspensions to set the suspensions on the carriage arms and then carries out a plurality of iterations of a crimping operation that presses a metal ball through crimping holes provided in the crimping portions while applying ultrasonic vibration to a crimping tool to crimp the suspensions to the carriage arms, wherein the suspensions are crimped to the carriage arms by setting a frequency of the ultrasonic vibration applied to the crimping tool during the crimping operation that presses the metal ball into the crimping holes so that the frequency is lower in later iterations of the crimping operation than in earlier iterations.

It is also effective to detect stress that acts on the crimping tool when the suspensions are crimped to the carriage arms and to control an amplitude of the ultrasonic vibration applied to the crimping tool so as to increase and decrease in accordance with the magnitude of the stress.

Yet another method of assembling a carriage assembly according to the present invention aligns attachment holes provided in front ends of carriage arms and crimping portions provided on suspensions to set the suspensions on the carriage arms and then presses an operation portion, which is formed at a front end of a crimping tool so that a maximum external diameter thereof is larger than an inner diameter of crimping holes provided in the crimping portions, through the crimping holes while applying ultrasonic vibration to the crimping tool to crimp the suspensions to the carriage arms, wherein the suspensions are crimped to the carriage arms by detecting stress that acts on the crimping tool when the operation portion passes through the crimping holes and controlling an amplitude of the ultrasonic vibration applied to the crimping tool so as to increase and decrease in accordance with a magnitude of the stress.

Another method of assembling a carriage assembly according to the present invention aligns attachment holes provided in front ends of carriage arms and crimping portions provided on suspensions to set the suspensions on the carriage arms and then carries out a plurality of iterations of a crimping operation that presses an operation portion, which is formed at a front end of a crimping tool so that a maximum external diameter thereof is larger than an inner diameter of crimping holes of the crimping portions, through the crimping holes while applying ultrasonic vibration to the crimping tool to crimp the suspensions to the carriage arms, wherein the suspensions are crimped to the carriage arms by setting a frequency of the ultrasonic vibration applied to the crimping tool during the crimping operation that presses the operation portion into the crimping holes so that the frequency is lower in later iterations of the crimping operation than in earlier iterations.

According to the method of assembling a carriage assembly according to the present invention, when applying ultrasonic vibration to a crimping tool to crimp suspensions to carriage arms using a metal ball or to crimp suspensions to carriage arms using a crimping tool equipped with an operation portion, the amplitude of the ultrasonic vibration applied to the crimping tool is controlled in accordance with the stress that acts on the crimping tool, or control is carried out to not apply ultrasonic vibration so that the suspensions can be crimped to the carriage arms more reliably without causing deformation of the suspensions or the crimping arms.

It is also an object of the present invention to provide a method of assembling a first member and a second member, without causing deformation of the first member and the second member by applying ultrasonic vibration to a crimping tool.

To achieve the stated object, a method of assembling a first member and a second member, comprising the steps of:aligning said first member and said second member;pressing a crimping tool into a crimping hole provided in either of said first member or said second member, and applying ultrasonic vibration to said crimping tool;detecting stress that acts on said crimping tool when said crimping tool is pressed into said crimping hole; and controlling an amplitude of said ultrasonic vibration applied to said crimping tool in accordance with a magnitude of detected stress.

### BRIEF DESCRIPTION OF THE DRAWINGS

The aforementioned and other objects and advantages of the present invention will become apparent to those skilled in the art upon reading and understanding the following detailed description with reference to the accompanying drawings.

In the drawings:

FIG. 1 is a diagram useful in explaining a method of assembling a carriage assembly according to the present invention;

FIG. 2 is a graph showing the stress that acts on a crimping tool and ultrasonic vibration applied to the crimping tool according to a first embodiment;

FIG. 3 is a graph showing the stress that acts on a crimping tool and ultrasonic vibration applied to the crimping tool according to a second embodiment;

FIG. 4 is a graph showing the stress that acts on a crimping tool and ultrasonic vibration applied to the crimping tool according to a third embodiment;

FIG. 5 is a diagram useful in showing another method of assembling a carriage assembly;

FIG. 6 is a diagram useful in showing the construction of a carriage assembly; and

FIG. 7 is a diagram useful in explaining a method of assembling a carriage assembly using a metal ball.

### DESCRIPTION OF THE PREFERRED EMBODIMENTS

Preferred embodiments of the present invention will now be described in detail with reference to the attached drawings.

Method of Assembling a Carriage Assembly

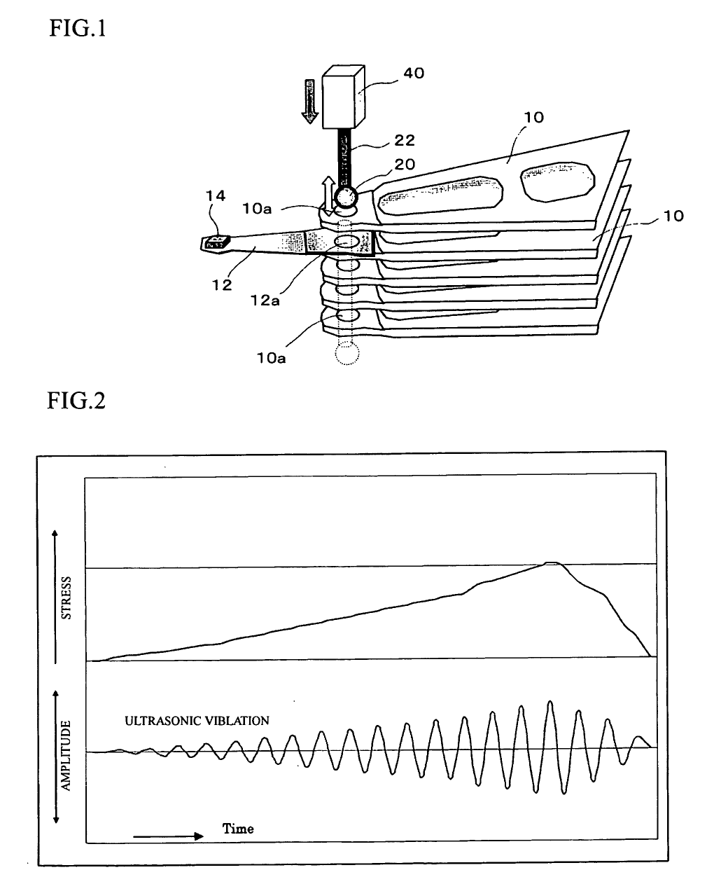

FIG. 1 is a diagram useful in explaining one embodiment of a method of assembling a carriage assembly according to the present invention. The method of assembling a carriage assembly according to the present embodiment crimps the suspensions 12 to the carriage arms 10 using the metal ball 20 described above. FIG. 1 shows a state where the suspensions 12 are crimped to the carriage arms 10 by pressing the metal ball 20 into crimping portions using the crimping tool 22 that is an ultrasonic horn provided in an ultrasound generating apparatus 40.

Note that attaching holes 10a are formed at the front ends of the carriage arms 10 and the crimping portions 12a formed at the base portions of the suspensions 12 are inserted into the attaching holes 10a to set the suspensions 12 on the carriage arms 10. As shown in FIG. 7, the crimping portions 12a of the suspensions 12 are formed as short cylinders and the suspensions 12 are set on the carriage arms 10 by fitting the crimping portions 12a into the attaching holes 10a.

The metal ball 20 is formed with a slightly larger diameter than the inner diameter of the crimping holes 10b of the crimping portions 12a formed on the suspensions 12, and after the metal ball 20 has been set on the crimping holes 12b, the metal ball 20 is pressed from above while applying ultrasonic vibration to the crimping tool 22 to pass the metal ball 20 through the crimping holes 12b. By passing the metal ball 20 through the crimping holes 12b, the crimping portions 12a are crimped to the carriage arms 10 in the same way as in the conventional art described above.

### First Embodiment

The method of assembling a carriage assembly according to the present invention is characterized by the method of controlling the ultrasonic vibration applied to the crimping tool 22.

FIG. 2 is a graph showing the relationship between the stress that acts on the crimping tool 22 and the amplitude of the ultrasonic vibration applied to the crimping tool 22 when ultrasonic vibration is applied to the crimping tool 22 and the metal ball 20 is pressed into and passed through the crimping holes 12b of the crimping portions 12a of the suspensions 12 according to the present embodiment.

The front end surface of the crimping tool 22 contacts the metal ball 20 so as to press the metal ball 20 into the crimping holes 12b of the crimping portions 12a. When carrying out a pressing operation using the crimping tool 22, after the metal ball 20 starts being pressed into a crimping hole, the stress that acts on the crimping tool 22 gradually increases, and when the metal ball 20 comes out of the crimping hole, the stress sharply falls to zero. That is, in a single crimping process where the metal ball 20 is pressed using the crimping tool 22, the pressing force of the crimping tool 22 changes so as to gradually increase from the start of pressing and to sharply fall after a point where the pressing force reaches a maximum.

FIG. 2 shows how the ultrasonic vibration applied to the crimping tool 22 is controlled so that the amplitude of the ultrasonic vibration is increased as the stress that acts on the crimping tool 22 increases and the amplitude of the ultrasonic vibration is decreased as the stress that acts on the crimping tool 22 decreases.

To adjust the amplitude of the ultrasonic vibration applied to the crimping tool 22 in accordance with the magnitude of the stress received by the crimping tool 22, the stress received by the crimping tool 22 may be constantly detected by the ultrasound generating apparatus 40, with the voltage applied to the ultrasound generator being increased or decreased based on the detection result.

In this way, by setting the amplitude of the ultrasonic vibration applied to the crimping tool 22 so as to change in accordance with changes in the magnitude of the stress (pressing force) that acts on the crimping tool 22, it is possible to carry out crimping reliably without deformation of the suspensions 12 and the carriage arms 10.

That is, by reducing the amplitude of the ultrasonic vibration when the metal ball 20 is set on a crimping hole and pressing of the metal ball 20 starts, it is possible to prevent the metal ball 20 from moving violently (i.e. to prevent the metal ball 20 from being displaced), and by doing so the pressing of the metal ball 20 can be started with the metal ball 20 reliably positioned on a crimping hole. Also, when the metal ball 20 is pressed inside the crimping hole and the stress increases, by increasing the amplitude of the ultrasonic vibration, it is possible to strengthen the vibration that acts on the metal ball 20 and thereby reduce the stress between the metal ball 20 and the crimping portion.

In this way, it is possible to position the metal ball 20 correctly on a crimping hole and pass the metal ball 20 through the crimping hole, and by reducing the stress when the metal ball 20 passes through the respective crimping holes, it is possible to suppress deformation of the suspensions 12 and the carriage arms 10.

### Second Embodiment

As shown in FIG. 1, the carriage assembly is constructed of a plurality of carriage arms 10 and in the assembling process of the carriage assembly, in a state where the suspensions 12 have been set on the individual carriage arms 10, the individual suspensions 12 are crimped while pressing a crimping tool 22 downward from above.

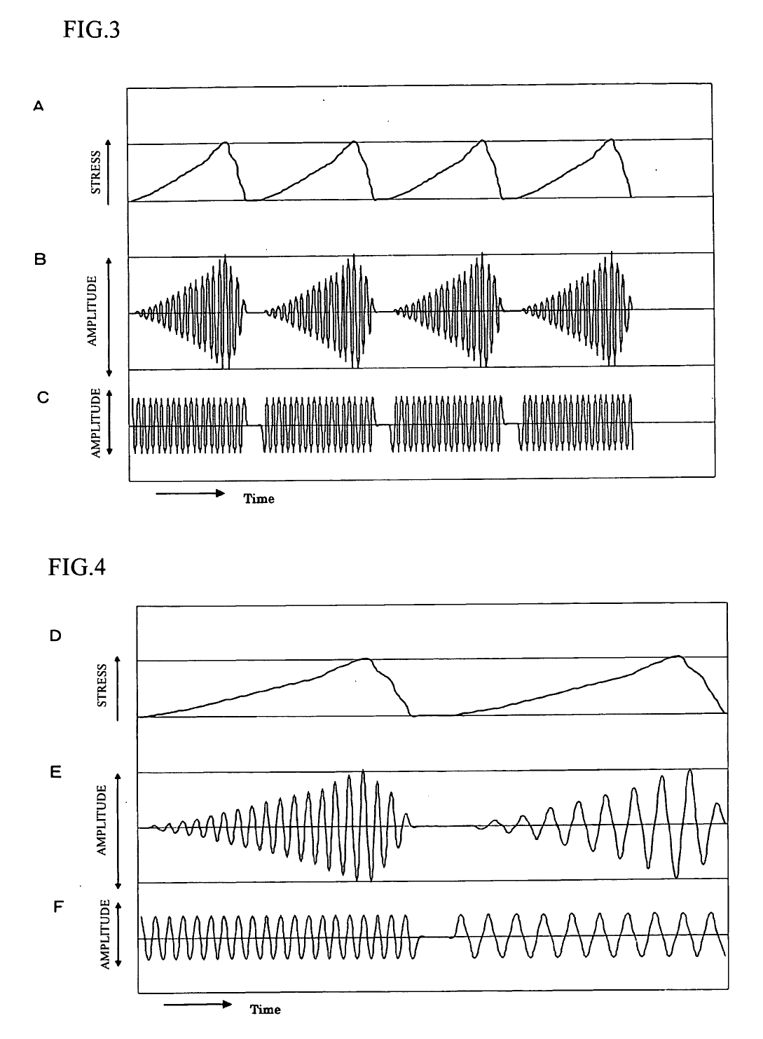

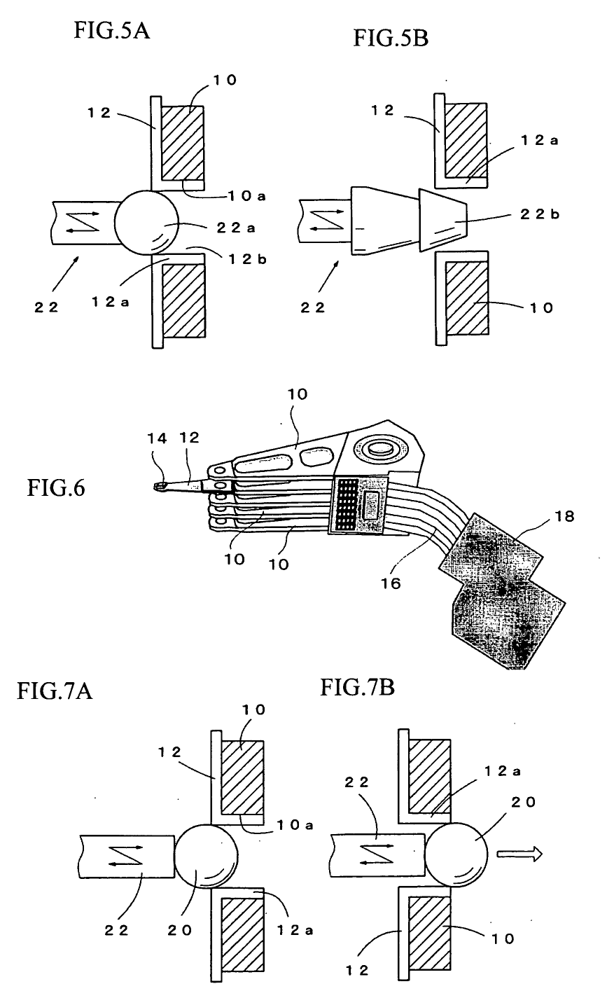

FIG. 3 shows how during the consecutive crimping of suspensions 12 onto the carriage arms 10, ultrasonic vibration is not applied to the crimping tool 22 when the metal ball 20 has come out of a crimping hole 12b and is at an intermediate position for insertion into the next crimping hole 12b.

In FIG. 3, graph A shows the stress that acts on the crimping tool 22 when crimping the suspensions 12 to the carriage arms 10 on the respective levels. In the same way as in FIG. 2, the stress gradually increases from the start of the metal ball 20 being pressed into a crimping hole and falls to zero once the metal ball 20 comes out of the crimping hole.

Graph B shows an example of control that increases and decreases the amplitude of the ultrasonic vibration applied to the crimping tool 22 in accordance with the stress that acts on the crimping tool 22 when crimping the suspensions 12 to the individual carriage arms 10. Graph C shows an example where the amplitude of the ultrasonic vibration applied to the crimping tool 22 when crimping the suspensions 12 to the individual carriage arms 10 is fixed.

In the control methods shown in graphs B and C in FIG. 3, control is carried out so that ultrasonic vibration is not applied to the metal ball 20 when the metal ball 20 has come out of a crimping hole. When using a method where the metal ball 20 is successively passed through crimping holes using the crimping tool 22, the metal ball 20 that has come out of a crimping hole will fall under its own weight to the crimping hole of the suspension 12 set on the next carriage arm 10 lower down. Accordingly, as in the present embodiment, by not applying ultrasonic vibration to the metal ball 20 that has come out of a crimping hole (i.e., by making the amplitude zero), it is possible to suppress displacement of the metal ball 20 during movement to the next level down, and therefore crimping can be carried out stably without damaging the peripheral portions of the crimping holes.

In the present embodiment also, as shown in graph B, by carrying out control that increases and decreases the amplitude of the ultrasonic vibration applied to the crimping tool 22 in accordance with the stress that acts on the crimping tool 22, it is possible to assemble a carriage assembly with reduced deformation of the suspensions 12 and the like more reliably.

### Third Embodiment

There is another method of assembling a carriage assembly by crimping suspensions 12 to carriage arms 10 using a metal ball 20 where two types of metal ball 20 with different external diameters are provided and in a first process (first iteration), the smaller of the metal balls 20 is passed through the crimping holes 12b and in a second process (second iteration), the larger of the metal balls 20 is passed through the crimping holes 12b. This method has an object of suppressing deformation of the suspensions 12 and the like by dividing the crimping (reshaping) caused by the metal ball 20 into two processes. This is because the suspensions 12 and the like are susceptible to deformation if significant crimping (reshaping) is caused by a single operation that passes a metal ball 20 through the crimping holes.

FIG. 4 shows control carried out to change the frequency of the ultrasonic vibration applied to the crimping tool 22 during the first process and the frequency of the ultrasonic vibration applied to the crimping tool 22 during the second process when crimping the suspensions 12 to the carriage arms 10 by moving a metal ball 20 through the crimping holes twice.

Graph D shows the stress that acts on the crimping tool 22 during a first iteration and a second iteration when the metal ball 20 passes through the crimping holes twice. Graphs E and F show the ultrasonic vibration applied to the crimping tool 22 during the first iteration and the second iteration. Graph E shows an example of control where the amplitude of the ultrasonic vibration is increased and decreased in accordance with the stress that acts on the crimping tool 22 and the frequency of the ultrasonic vibration during the second iteration is lower than during the first iteration. Graph F shows an example of control where the amplitude of the ultrasonic vibration applied to the crimping tool 22 is constant during the first iteration and the second iteration and the frequency of the ultrasonic vibration during the second iteration is lower than during the first iteration.

There is a characteristic whereby when the frequency of the ultrasonic vibration applied to the metal ball 20 by the crimping tool 22 increases, the stress decreases, and when the frequency falls, the stress increases. Accordingly, as shown in graphs E and F, if the frequency during the second iteration is made lower than during the first iteration, it is possible to produce larger stress (i.e., more crimping) between the metal ball 20 and the crimping holes compared to during the first iteration.

According to this method, effective crimping can be achieved by using the same metal ball 20 in the second iteration as in the first iteration.

In a crimping process that uses a metal ball 20, a new metal ball 20 is used for each crimping iteration (process). In the present embodiment also, it should be obvious that a new metal ball 20 may be used in the second iteration. By using the same metal ball 20 in the first iteration and the second iteration, it is possible to reduce the manufacturing cost. Even if a new metal ball 20 is used during the second iteration, according to the method of the present embodiment, unlike the conventional method, there is the advantage that there is no need to provide metal balls with different external diameters and metal balls 20 of the same type (i.e., the same diameter) may be used.

Alternative Method of Assembling a Carriage Assembly

In the above embodiments, examples of methods where a carriage assembly is assembled by crimping the suspensions 12 to the carriage arms 10 using the metal ball 20 have been described. However, the present invention is not limited to a method that crimps using a metal ball 20. FIGS. 5A and 5B show examples where crimping is carried out using a crimping tool 22 where an operation portion for crimping is integrally provided on the tool. FIG. 5A shows an example where a ball-shaped operation portion 22a is provided at the front end of the tool, while FIG. 5B shows an example where a wedge-shaped portion 22b is provided. These operation portions 22a, 22b are provided so that the diameters thereof at the widest points are slightly larger than the internal diameter of the crimping holes 12b, and by pressing the operation portions 22a, 22b into and through the crimping holes 12b, it is possible to crimp the suspensions 12 to the carriage arms 10 in the same way as when the metal ball 20 is used.

FIGS. 5A and 5B show methods where the suspensions 12 are set on the carriage arms 10 and then the operation portions 22a, 22b are passed through the crimping holes 12b of the crimping portions 12a of the suspensions 12 so that the crimping holes 12b are widened by the operation portions 22a, 22b to crimp the suspensions 12 to the carriage arms 10.

In this way, by integrally providing the operation portions 22a, 22b on the crimping tool 22, in the same way as the embodiments described above, it is possible to use a method that (i) detects the stress when the metal ball 20 is pressed in by the crimping tool 22 and increases and decreases the amplitude of the ultrasonic vibration in accordance with the stress, (ii) stops the ultrasonic vibration after the operation portion has come out of a crimping hole and is at an intermediate position for insertion into the next crimping hole, and/or (iii) sets the frequency of the ultrasonic vibration lower during a second iteration than during a first iteration when crimping is carried out by passing the crimping tool 22 through the crimping holes twice. By doing so, it is possible to assemble a carriage assembly while suppressing deformation of the suspensions 12 and the carriage arms 10 during crimping.

What is claimed is:

1. A method of assembling a first member and a second member, comprising the steps of:
aligning said first member and said second member;
pressing a crimping tool into a crimping hole provided in either of said first member or said second member, and applying ultrasonic vibration to said crimping tool;
detecting stress that acts on said crimping tool when said crimping tool is pressed into said crimping hole; and
controlling an amplitude of said ultrasonic vibration applied to said crimping tool in accordance with a magnitude of detected stress.

2. A method of assembling a carriage assembly that aligns attachment holes provided in front ends of carriage arms and crimping portions provided on suspensions to set the suspensions on the carriage arms and then presses a metal ball through crimping holes provided in the crimping portions while applying ultrasonic vibration to a crimping tool to crimp the suspensions to the carriage arms,
wherein the suspensions are crimped to the carriage arms by detecting stress that acts on the crimping tool when the metal ball is pressed in by the crimping tool and controlling an amplitude of the ultrasonic vibration applied to the crimping tool so as to increase and decrease in accordance with the magnitude of the stress.

3. A method of assembling a carriage assembly that aligns attachment holes provided in front ends of carriage arms and crimping portions provided on suspensions to set the suspensions on the carriage arms that are disposed on a plurality of levels and then presses a metal ball successively through crimping holes provided in the crimping portions while applying ultrasonic vibration to a crimping tool to crimp the suspensions to the carriage arms,
wherein the suspensions are crimped to the carriage arms by carrying out control to not apply ultrasonic vibration to the crimping tool when the metal ball has come out of a crimping hole on an upper level and is at an intermediate position for insertion into a crimping hole on a next level.

4. A method of assembling a carriage assembly that aligns attachment holes provided in front ends of carriage arms and crimping portions provided on suspensions to set the suspensions on the carriage arms and then carries out a plurality of iterations of a crimping operation that presses a metal ball through crimping holes provided in the crimping portions while applying ultrasonic vibration to a crimping tool to crimp the suspensions to the carriage arms,
wherein the suspensions are crimped to the carriage arms by setting a frequency of the ultrasonic vibration applied to the crimping tool during the crimping operation that presses the metal ball into the crimping holes so that the frequency is lower in later iterations of the crimping operation than in earlier iterations.

5. A method of assembling a carriage assembly according to claim 3, wherein stress that acts on the crimping tool when the suspensions are crimped to the carriage arms is detected and an amplitude of the ultrasonic vibration applied to the crimping tool is controlled so as to increase and decrease in accordance with the magnitude of the stress.

6. A method of assembling a carriage assembly according to claim 4, wherein stress that acts on the crimping tool when the suspensions are crimped to the carriage arms is detected and an amplitude of the ultrasonic vibration applied to the crimping tool is controlled so as to increase and decrease in accordance with the magnitude of the stress.

7. A method of assembling a carriage assembly that aligns attachment holes provided in front ends of carriage arms and crimping portions provided on suspensions to set the suspensions on the carriage arms and then presses an operation portion, which is formed at a front end of a crimping tool so that a maximum external diameter thereof is larger than an inner diameter of crimping holes provided in the crimping portions, through the crimping holes while applying ultrasonic vibration to the crimping tool to crimp the suspensions to the carriage arms,
wherein the suspensions are crimped to the carriage arms by detecting stress that acts on the crimping tool when the operation portion passes through the crimping holes and controlling an amplitude of the ultrasonic vibration applied to the crimping tool so as to increase and decrease in accordance with a magnitude of the stress.

8. A method of assembling a carriage assembly that aligns attachment holes provided in front ends of carriage arms and crimping portions provided on suspensions to set the suspensions on the carriage arms and then carries out a plurality of iterations of a crimping operation that presses an operation portion, which is formed at a front end of a crimping tool so that a maximum external diameter thereof is larger than an inner diameter of crimping holes of the crimping portions, through the crimping holes while applying ultrasonic vibration to the crimping tool to crimp the suspensions to the carriage arms,
wherein the suspensions are crimped to the carriage arms by setting a frequency of the ultrasonic vibration applied to the crimping tool during the crimping operation that presses the operation portion into the crimping holes so that the frequency is lower in later iterations of the crimping operation than in earlier iterations.
